(19) United States
(12) Patent Application Publication
(10) Pub. No.: US 2026/0104271 A1
(43) Pub. Date: Apr. 16, 2026

(54) Method for Operating a System for the Monitoring of a Transport Container for Freight Transport

(71) Applicants: Deutsche Post AG, Bonn (DE); Telic AG, Oberhaching (DE)

(72) Inventors: Stephan Wahlen, Bonn (DE); Andreas Kirst, Kirchheim (DE); Stefan Baumann, München (DE)

(21) Appl. No.: 18/913,345

(22) Filed: Oct. 11, 2024

(30) Foreign Application Priority Data
Oct. 13, 2023 (DE) 10 2023 128 104.6

(51) Int. Cl. G01D 5/14; G01S 19/14

(52) U.S. Cl. CPC G01D 5/14; G01S 19/14

(57) ABSTRACT

A system for the monitoring of a transport container for freight transport having a gate for the opening and closing of the transport container, the system including: a sensor unit for the capture of a gate status, wherein the gate status comprises at least one open state of the gate and one closed state of the gate; a position determination module for capturing a location of the transport container; a communication module for the wireless transmission of data, including the gate status and the location of the transport container, to a central control unit, wherein the central control unit is designed to receive data from the communication module and, depending upon the gate status and the location of the transport container, to transmit a warning message to an external receiver.

### CROSS-REFERENCE TO RELATED APPLICATIONS

The present application is based upon and claims the right of priority to DE Patent Application No. 10 2023 128 104.6, filed Oct. 13, 2023, the disclosure of which is hereby incorporated by reference herein in its entirety for all purposes.

The invention relates to a method for operating a system for the monitoring of a transport container for freight transport having a gate for the opening and closing of the transport container, which system comprises a sensor unit for the capture of a gate status, wherein the gate status comprises at least one open state of the gate and one closed state of the gate, a position determination module for capturing a location of the transport container, and a communication module for the wireless transmission of data, including the gate status and the location of the transport container, to a central control unit.

In transportation, freight transport describes the off-site carriage of goods by the transport and traffic routes of road, rail, water and air. Goods are generally carried in large transport receptacles such as, for example, containers. In widespread practice, the container is configured as a swap body container towed by a truck unit. A swap body container or swap body trailer (SBT) is an interchangeable load carrier, under which the carrier vehicle is driven or which is hoisted by crane, and which can also be uncoupled. Swap body containers are now the most commonly employed transport technology for continental European combined transport operations.

In many cases, goods are susceptible to theft or damage during transport. This can be attributable, either to the driver themselves or to a third party, for example during mandatory breaks in rest areas or at service stations. Missing or damaged goods represent an enormous loss and, in many cases, traceability is not possible. Both thefts and damage are associated with the same precondition, namely, the unauthorized opening of the transport container.

Under ideal circumstances, the transport container undergoes regulation loading at the starting location, is closed, and is only reopened and unloaded at its destination. It is therefore necessary that any unauthorized openings of the transport container should be detectable, in order to permit the tracking of any potential thefts or damage to goods. A corresponding function can also serve as a deterrent, and protect against thefts or damage.

To date, the devices or methods which are known from the prior art do not permit the detection of unauthorized openings of a transport container during transport.

In this context, the object of the invention is the provision of a system and method by means of which a gate of the transport container can be monitored during transport, and any unauthorized openings can be detected.

This object is fulfilled by the subject matter of patent Claim 1. Preferred further developments are disclosed in the dependent claims.

According to the invention, a system is thus provided for monitoring a transport container for the carriage of goods, having a gate for the opening and closing of the transport container, which system comprises:
a sensor unit for capturing a gate status, wherein the gate status comprises at least one open state of the gate and one closed state of the gate;
a position determination module for capturing a location of the transport container;
a communication module for the wireless transmission of data, including the gate status and the location of the transport container, to a central control unit, wherein the central control unit is designed to receive data from the communication module and, depending upon the gate status and the location of the transport container, to transmit a warning message to an external receiver.

In the present context, a “transport container” is understood as any transport container which is appropriate for the carriage of goods. In particular, these include containers, high-capacity receptacles, swap body containers and/or swap body trailers. The transport container is provided with a gate, by means of which access to the transport container is enabled. In particular, a gate is understood as a swing gate, a roller shutter, a door or a tarpaulin, which can be opened at a predetermined location.

A “position determination module” is understood in particular as a GNSS module. “GNSS” is the abbreviation for “global navigation satellite system”, and signifies a global navigation satellite system for position determination and navigation on land and in the air by the reception of signals from navigation satellites and pseudolites. GNSS is a collective term for the employment of existing and future global satellite systems such as, for example, the NAVSTAR GPS of the United States of America, GLONASS of the Russian Federation, GALILEO of the European Union or BEIDOU of the People's Republic of China, together with various supplementary systems in Europe, the USA, Japan and India. The central control unit represents a connection unit between the position determination module or communication module and the external receiver.

It is thus a critical point of the invention that, by means of the system, not only gate openings can be detected, but the gate status can also be captured and evaluated in combination with the location of the transport container. Depending upon these two key elements of information, namely, the gate status and the location, further actions can then be executed such as, in particular, notification of an external receiver to the effect that a transport container has been illicitly opened, and where.

Information on the gate status is particularly transmitted in the form of cyclical advertising data in the immediate environment. The communication module receives data at regular intervals and transmits the latter to the central control unit, which scans the relevant information and can generate a warning message output.

Transmitted data, in addition to an “open” or “closed” gate status, preferably include a counter value for the number of gate openings. In the absence of the provision and evaluation of the counter value, brief openings of the gate cannot be detected. This counter value, in the event of the capture of advertising data at longer intervals (e.g. 2-3 minutes) permits the detection of a brief opening of the rolling shutter in the time interval between the capture of advertising data.

The sensor unit preferably comprises two components, namely, a magnetic sensor and a magnet by way of a corresponding mating component. The sensor unit is operated using the Bluetooth Low-Energy (BLE) standard. The magnetic sensor and the magnet are fitted such that, in the closed state of the gate, the magnet is arranged at the height of the magnetic sensor. If the gate is opened, the position of the magnet is altered, to the effect that it is removed from the magnetic sensor to the extent that it is located outside the detection zone of the magnetic sensor, such that the opening of the gate can be detected. Bluetooth Low-Energy (BLE) is a radio technology, by means of which devices within a surrounding area of the order of 10 to 20 metres can be networked. In comparison with communication systems having a similar transmission range but without BLE, BLE features a significantly lower current consumption and generates lower costs.

According to a preferred further development of the invention, the sensor unit is designed to transmit the gate status wirelessly to the position determination module. The gate status is preferably communicated via Bluetooth. According to a preferred further development of the invention, the position determination module incorporates the communication module, and is designed to transmit data to the central control unit, preferably by means of cellular radio communication. The design is consequently selected such that the communication module is integrated in the position determination module. Sensor data, i.e. the gate status, are transmitted to the position determination module. Sensor data are enriched by GNSS-detected current positional data, and communicated via cellular radio networks, preferably public cellular radio networks, to the central control unit, and thus to the logistics centre. The central control unit can be located, for example, in a logistics centre which is remote from the transport route and can receive data.

According to the invention, a method is further provided for operating an above-mentioned system, having the following process steps:
prior definition of at least one unmonitored geolocation zone;
capture of the gate status by means of the sensor unit at regular time intervals;
capture of the location of the transport container by means of the position determination module, at regular time intervals;
in the event of the capture of an open gate and the capture of a location of the transport container outside the unmonitored geolocation zone, transmission of a warning message to the external receiver by means of the central control unit.

It is thus a critical point of the invention that “geolocation zones” are defined in which no monitoring of the gate status is to be executed. In particular, these include the starting location and/or the destination, at which the opening of the transport container for loading and/or unloading is permitted. In these zones, any monitoring of gate status is not desired. Correspondingly, in the converse case, only such gate openings are notified which occur externally to the unmonitored zones, i.e. particularly between the starting location and the destination, namely, during transport.

If a gate opening is detected, and the transport container is located outside the unmonitored zone, the communication module transmits data to the central control unit, which scans the relevant information and generates a warning message output.

Data which are transmitted, in addition to an “open” or “closed” gate status, preferably include a counter value for the number of gate openings. In the absence of the provision and evaluation of the counter value, brief openings of the gate cannot be detected. This counter value, in the event of the capture of data at longer intervals (e.g. 2-3 minutes) permits the detection of a brief opening of the rolling shutter in the time interval between the capture of data.

An alteration of the gate status can preferably be determined in two ways: firstly, the alteration of the gate status can be detected by a change in the counter value, wherein the gate status apparently remains unchanged. Secondly, an alteration of the gate status can be detected by reference to the gate status itself. This occurs particularly where the gate status has changed, for example from “closed” to “open”, since the most recent transmission of data.

In particular, the definition of geolocation zones and the capture of a location permit the automated tripping of an action in the event of the overshoot of a geolocation boundary on the earth's surface or in the air. This is also described as “geofencing”. In the majority of cases, the boundary defines an enclosed area, such that a distinction can be drawn between the interior and the exterior thereof. It is preferably provided that, upon the entry or exit of the transport container to or from the unmonitored zone, a communication is transmitted to the central control unit. It is preferably provided that the exit of the transport container from the geolocation zone initiates or triggers the system and method according to the invention, and/or that the entry of the transport container to the geolocation zone terminates or interrupts the system and method according to the invention.

According to a preferred further development of the invention, the gate is detected as open if the dimension of the opening exceeds a predefined limiting value, and is detected as closed if the dimension of the opening undershoots the predefined limiting value. The term “predefined dimension” specifically signifies a limiting value. For example, a rolling shutter is classified as open if the opening exceeds a dimension of 5 cm. A swing gate, for example, is classified as open if the opening exceeds a dimension of 5°. The gates are respectively classified as closed if the respective limiting values are undershot.

According to a preferred further development of the invention, the method comprises the following further process step:
if the gate has been detected as open, transmission of the gate status and of the location of the transport container to the central control unit is then executed.

Transmission of the gate status as a data pair in combination with the location is preferably executed independently of the location of the transport container. Any alteration of the gate status is communicated in combination with the respective location. Communication is executed in the context of a push model. This means that, in the event of an alteration of the gate status, data, i.e. the gate status and the temporally assigned location, are automatically transmitted to the central control unit. Only then can it be decided whether a warning message is necessary. In particular, a warning message will then be necessary in the event that the location of the transport container at the time of the gate opening has been identified outside the unmonitored zone. This evaluation is executed by means of the central control unit.

If a location is identified immediately in advance, or within a predefined tolerance margin in advance of the detection of a gate opening, for example on the grounds that the position of the transport container has been communicated during an immobilization of the vehicle, this location can be assigned to the gate opening event, such that the execution of any further location identification is not necessary. Otherwise, further to the detection of a gate opening, it is then preferably endeavoured for a predefined time interval, for example one minute, to capture a current location which can be assigned to the gate opening event. If this is not possible, the most recently identified location is assigned.

In particular, if no data connection is available further to an alteration of the gate status, data will be buffered. Upon the next data transmission, the saved message regarding the alteration of the gate status will then be delivered ex-post.

According to a preferred further development of the invention, the method comprises the following further process step:
transmission of the gate status and of the location of the transport container to a central control unit at regular time intervals.

Additionally or alternatively to the push model, data can also be polled at regular time intervals. This is executed in the context of the pull model. The gate status, in combination with the location of the transport container, can thus be polled, for example, every 10 minutes, and additionally employed as evidence of transport, independently of the location of the transport container, even if no unauthorized gate opening has been detected.

According to a preferred further development of the invention, the gate status and/or the location of the transport container are respectively communicated as a time-stamped data pair. The function of the time stamp is the assignment of an event to an unambiguous time point. Each reading of the gate status and/or of the location of the transport container can thus be assigned to an unambiguous time point, such that data thus determined can be traced in a chronological sequence, and a transport process can be reconstructed accordingly. It is particularly preferred that an identification number is assigned to the transport container which, in combination with the gate status and/or the location of the transport container, is communicated to the central control unit. If a plurality of transport containers are simultaneously monitored by the central control unit, events can be unambiguously assigned to the individual transport containers.

Evidence as to where, when, and for what duration a gate has been opened is particularly important for insurance claims in the event of a theft and/or as proof to the client that carriage has been executed in a regulation manner, i.e. with no unauthorized opening.

According to a preferred further development of the invention, the method comprises the following further process steps:
prior definition of a start time and a target time for the carriage of the transport container, and
communication of the gate status and/or of the location of the transport container and/or transmission of a warning message in the event that the respective time stamp lies between the start time and the target time.

The method can not only be controlled by reference to the location of the transport container, but also by reference to time, in particular to the clock time. In the event of the prior definition of a start time and a target time, data and/or messages can only be transmitted within this time window. As exact compliance with predetermined start and/or target times is seldom possible in practice, for example on the grounds of delays in processing or impediments on transport routes, start and/or target times can preferably incorporate tolerance margins. Moreover, live traffic data can preferably be considered, such that at least the target time can undergo ongoing adjustment during transport.

According to the invention, an employment of an above-mentioned system for the execution of an above-mentioned method for monitoring a gate status of a transport container during transport is further provided.

The invention is described in greater detail hereinafter, with respect to a preferred exemplary embodiment and with reference to the drawings.

In the drawings:

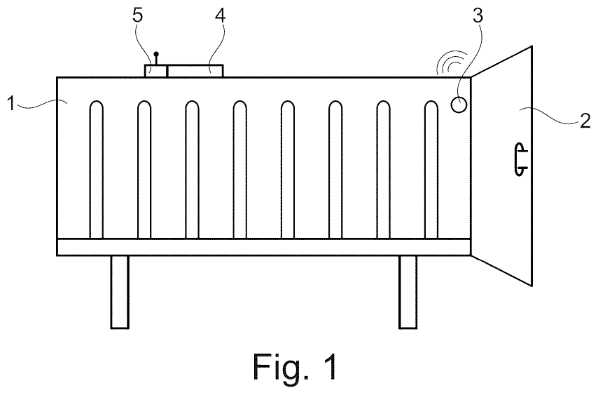

FIG. 1 shows a schematic representation of a transport container having a system for monitoring the transport container, according to a preferred exemplary embodiment of the invention, in a side view;

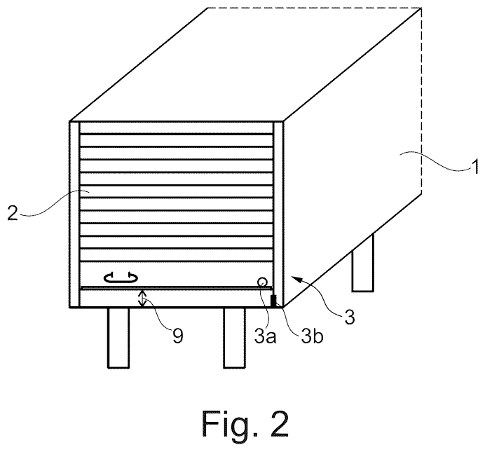

FIG. 2 shows a schematic representation of a transport container having a system for monitoring the transport container, according to a preferred exemplary embodiment of the invention, in a frontal view;

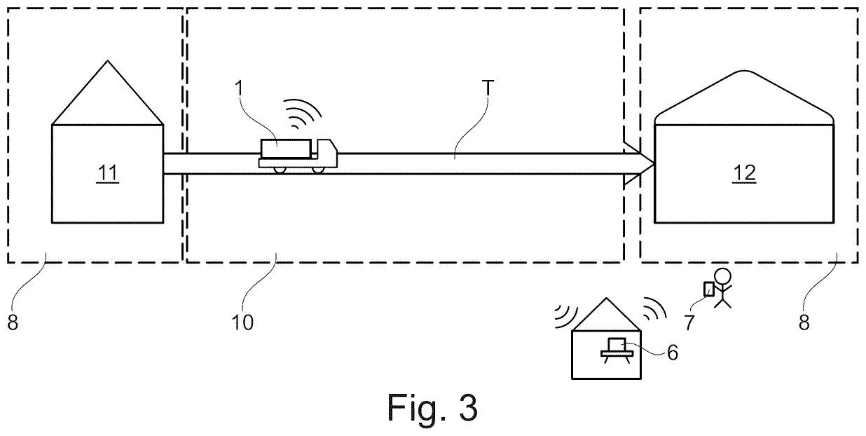

FIG. 3 shows a schematic representation of an exemplary application of the system for monitoring a transport container, according to a preferred exemplary embodiment of the invention;

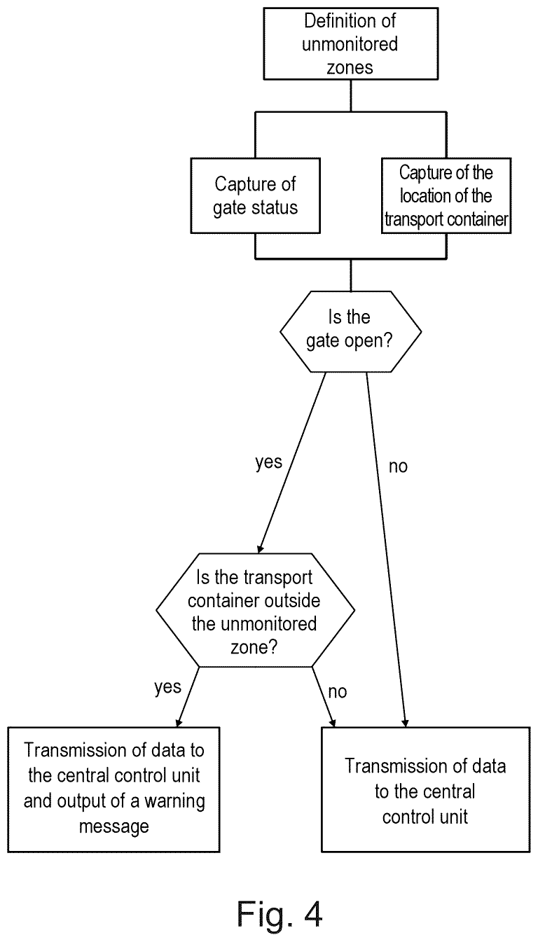

FIG. 4 shows a schematic representation of a method for monitoring a transport container according to a preferred exemplary embodiment of the invention, in a flow diagram.

FIG. 1 shows a schematic representation of a transport container 1 having a system for monitoring the transport container 1, according to a preferred exemplary embodiment of the invention, in a side view. The transport container 1, in the present case in the form of a swap body container, has a gate 2 on one side, via which the interior of the transport container 1 is accessible. The system for monitoring the transport container 1 is comprised of a sensor unit 3 and a position determination module 4 with an integrated communication module 5. In consequence, any arbitrary transport container 1 can be retrofitted with the system. To this end, the sensor unit 3 is simply arranged on the gate 2. The position determination module 4 can be arranged at an arbitrary location. Arrangement on the roof, as represented in FIG. 1, provides an advantage, in that the position determination module 4 can comprise a solar module for the supply of energy. The position determination module 4 can thus supply its own power during operation. The sensor unit 3 and the position determination module 4 can be fastened at different locations on the transport container 1, on the grounds that the sensor unit 3 can communicate wirelessly with the position determination module 4 or with the communication module 3. The sensor unit transmits data, i.e. the gate status, to the position determination module 4 via Bluetooth. In particular, the data transmission range is 10 to 20 metres, such that the position determination module 4 can be arranged, for example, at one end of the transport container 1, and the sensor unit 3 can be arranged at the other end of the transport container 1.

FIG. 2 shows a transport container 1, in a frontal view of the gate 2. The sensor unit 3, which can detect the gate status, is arranged on the gate 2. The sensor unit 3 comprises a magnet 3a and a magnetic sensor 3b which, in the closed state of the gate 2, are positioned at the same height. In FIG. 2, the gate 2 is opened, such that the magnet 3a and the magnetic sensor 3b are mutually offset, and the gate status is detected as “open”. The gate status is only detected as “open” in the event that the opening 9 exceeds a predefined limiting value. In this manner, it can be excluded that very small openings, which do not enable access to the transport container 1, are detected as “open”.

FIG. 3 shows an exemplary application of the system for monitoring the transport container 1. The transport container 1 is carried from the starting location 11 to the destination 12. The starting location 11 and the destination 12 are defined as unmonitored zone 8. Conversely, the monitored zone 10 is situated between the starting location 11 and the destination 12. Only in this monitored zone 10 is an opening of the gate 2 classified as critical. If the transport container 1 is located in the monitored zone 10 and the gate 2 is detected as “open”, a warning message is transmitted to an external receiver 7. To this end, the gate status and the location of the transport container 1 are communicated to a central control unit 6, which evaluates data.

During transport T, data, i.e. the gate status and the position of the transport container 1, can be progressively tracked, wherein they are either polled in the context of a pull mode and/or actively transmitted to the central control unit 6 in the context of a push mode, in response to changes of status. Independently of the location of the transport container 1, all openings of the gate 2 can be notified accordingly. Whether the output of a warning message is actually necessary is decided on the basis of the evaluation of data by the central control unit 6. Moreover, it is also possible for the location of the transport container 1 to be polled at regular time intervals, and for transport to be tracked accordingly.

The external receiver 7, as represented in FIG. 3, can be an uninvolved third party or an apparatus. However, it is also possible that the driver of the transport vehicle is the external receiver 7. In this case, the driver themselves can appraise any unauthorized opening of the gate 2 of the transport container 1.

FIG. 4 shows a schematic representation of a method for monitoring a transport container 1 according to a preferred exemplary embodiment of the invention. In a first step, unmonitored zones are defined. In these unmonitored zones, openings of the gate 2 are classified as non-critical. Unmonitored zones are, for example, the starting location 11, at which the transport container 1 is loaded, and the destination 12, at which the transport container is unloaded. Unmonitored zones are defined as a preparatory step, prior to the transport of the transport container 1. During transport T, the gate status and the location of the transport container 1 are captured. If the gate is detected as “closed”, the location and the gate status are communicated to the central control unit 6 for the purposes of documentation. However, if the gate is detected as “open”, a check is executed as to whether the transport container 1 is located outside the unmonitored zone. If the transport container 1 is located outside the unmonitored zone, not only data comprising the gate status and the location of the transport container 1 are communicated to the central control unit 6, but a warning message is also transmitted to an external receiver 7. It is thus a critical point that a warning message is only transmitted to the external receiver 7 in the event that the transport container 1 has been identified outside the unmonitored zone 8 and the gate has been detected as “open”. In this manner, unauthorized openings during transport T between the starting location 11 and the destination 12 are notified.

The gate status and the location of the transport container 1 are respectively communicated with a time stamp. By means of the time stamp, events during transport T can be tracked in a chronological sequence. A report to this effect, for example, can be delivered to a client. In particular, evidence as to where, when and for what duration a gate has been opened is also critical to insurance claims in the event of theft or damage.

### LIST OF REFERENCE NUMBERS

1 Transport container
2 Gate
3 Sensor unit
3a Magnet
3b Magnetic sensor
4 Position determination module
5 Communication module
6 Central control unit
7 External receiver
8 Unmonitored geolocation zone
9 Opening
10 Monitored zone
11 Starting location
12 Destination
T Transport (route)

1. A method for operating a system for the monitoring of a transport container for freight transport having a gate for the opening and closing of the transport container, which system comprises:
a sensor unit for the capture of a gate status, wherein the gate status comprises at least one open state of the gate and one closed state of the gate;
a position determination module for capturing a location of the transport container;
a communication module for the wireless transmission of data, including the gate status and the location of the transport container, to a central control unit, wherein the central control unit is designed to receive data from the communication module and, depending upon the gate status and the location of the transport container, to transmit a warning message to an external receiver, having the following process steps:
prior definition of at least one unmonitored geolocation zone;
prior definition of a start time and a target time for the carriage of the transport container;
capture of the gate status by means of the sensor unit at regular time intervals;
capture of the location of the transport container by means of the position determination module at regular time intervals, wherein the gate status and/or the location of the transport container are respectively communicated as a time-stamped data pair; and
in the event of the capture of an open gate and the capture of a location of the transport container outside the unmonitored geolocation zone, and in the event that the respective time stamp lies between the start time and the target time, transmission of a warning message to the external receiver by means of the central control unit.

2. The method according to claim 1, wherein the sensor unit is designed to transmit the gate status wirelessly to the position determination module.

3. The method according to claim 1, wherein the position determination module incorporates the communication module, and is designed to transmit data to the central control unit by means of a cellular radio network.

4. The method according to claim 1, wherein the gate is detected as open if the dimension of the opening exceeds a predefined limiting value, and the gate is detected as closed if the dimension of the opening undershoots the predefined limiting value.

5. The method according to claim 1, comprising the following further process step:
if the gate has been detected as open, transmission of the gate status and of the location of the transport container to the central control unit.

6. The method according to claim 1, comprising the following further process step:
transmission of the gate status and of the location of the transport container to a central control unit at regular time intervals.

7. The method according to claim 1, wherein at least one of the gate status and the location of the transport container are respectively communicated as a time-stamped data pair.

8. The method according to the claim 7, comprising the following further process steps:
prior definition of a start time and a target time for the carriage of the transport container; and
transmission of at least one of the gate status and of the location of at least one of the transport container and transmission of a warning message in the event that the respective time stamp lies between the start time and the target time.

9. Application of the method according to claim 1 for monitoring a gate status of a transport container during transport.
